(19) United States
(12) Patent Application Publication
(10) Pub. No.: US 2024/0169361 A1
(43) Pub. Date: May 23, 2024

(54) SYSTEMS AND METHODS FOR CAPTURING SENTIMENTS AND DELIVERING ELEVATED PROACTIVE USER EXPERIENCE

(71) Applicant: JPMORGAN CHASE BANK, N.A., New York, NY (US)

(72) Inventors: Kevin J MCNAMARA, Newfoundland, NJ (US); Rohit TALREJA, Hyderabad (IN); Scott QUINLIN, New York, NY (US)

(21) Appl. No.: 18/149,349

(22) Filed: Jan. 3, 2023

(30) Foreign Application Priority Data
Nov. 21, 2022 (IN) 202211066798

(51) Int. Cl. G06Q 30/015; G06N 5/022

(52) U.S. Cl. CPC G06Q 30/015; G06N 5/022

(57) ABSTRACT

Systems and methods for capturing sentiments and delivering elevated proactive user experience are disclosed. In one embodiment, a method may include a solution recommendation computer program: receiving, from a user electronic device, a message comprising an identifier for a computer issue; identifying, using a trained machine learning engine, a solution category for the computer issue, wherein the trained machine learning engine is trained using historical service data and historical sentiment scores; retrieving a custom solution for the solution category from a knowledge base; determining whether the custom solution was successful; in response to the custom solution being unsuccessful, requesting feedback on the custom solution from the user electronic device; receiving the feedback from the user electronic device; assigning a sentiment score to the custom solution based on the feedback, wherein the sentiment scores is positive, neutral, or negative; and retraining the trained machine learning engine using the sentiment score.

### BACKGROUND OF THE INVENTION

### 1. Field of the Invention

Embodiments generally relate to systems and methods for capturing sentiments and delivering elevated proactive user experience.

### 2. Description of the Related Art

Information technology departments in large organizations often provide self-service systems for users seeking to resolve minor issues. A disorganized and lacking self-service system increases user frustration in solving their specific ticket issue. Searching for multiple, often irrelevant, knowledge articles, different applications for general support, a lack of ability to easily contact representatives, and confusing terminology often results in an influx of reopened tickets. Often, the users that provide feedback are those that experienced some difficulty in resolving the issue.

### SUMMARY OF THE INVENTION

Systems and methods for capturing sentiments and delivering elevated proactive user experience are disclosed. In one embodiment, a method may include: (1) receiving, by a solution recommendation computer program that is executed by an electronic device and from a user electronic device for user, a message comprising an identifier for a computer issue, an application issue, a network issue, or a remote location issue; (2) identifying, by the solution recommendation computer program and using a trained machine learning engine, a solution category for the computer issue, wherein the trained machine learning engine is trained using historical service data and historical sentiment scores; (3) retrieving, by the solution recommendation computer program, a custom solution for the solution category from a knowledge base; (4) determining, by the solution recommendation computer program, whether the custom solution was successful; (5) in response to the custom solution being unsuccessful, requesting, by the solution recommendation computer program, feedback on the custom solution from the user electronic device; (6) receiving, by the solution recommendation computer program, the feedback from the user electronic device; (7) assigning, by the solution recommendation computer program, a sentiment score to the custom solution based on the feedback, wherein the sentiment scores is positive, neutral, or negative; and (8) retraining, by the solution recommendation computer program, the trained machine learning engine using the sentiment score.

In one embodiment, the method may also include identifying, by the solution recommendation computer program, a format for the custom solution; wherein the solution recommendation computer program provides the custom solution in the format.

In one embodiment, the format may include one of an article, a video, and a script. The format may be selected based on a prior custom solution that was provided to the user, a success rate for the format, etc.

In one embodiment, the feedback may be requested using an out-of-band communication channel.

In one embodiment, the solution recommendation computer program may determine whether the custom solution was successful by monitoring operation of the user electronic device.

In one embodiment, in response to the custom solution being successful, the method may also include assigning, by the solution recommendation computer program, a neutral sentiment score for the custom solution.

According to another embodiment, a system may include a user electronic device associated with a user; an electronic device executing a solution recommendation computer program and a trained solution recommendation machine learning engine; and a solution knowledge base comprising solution knowledge. The solution recommendation computer program receives a message comprising an identifier for a computer issue, an application issue, a network issue, or a remote location issue from the user electronic device, identifies, using the trained solution recommendation machine learning engine, a solution category for the computer issue, retrieves a custom solution for the solution category from the solution knowledge base, determines whether the custom solution was successful, in response to the custom solution being unsuccessful, requests feedback on the custom solution from the user electronic device, receives the feedback from the user electronic device, assigns a sentiment score to the custom solution based on the feedback, wherein the sentiment score is positive, neutral, or negative, and retrains the trained solution recommendation machine learning engine using the sentiment score.

In one embodiment, the solution recommendation computer program may identify a format for the custom solution and provides the custom solution in the format.

In one embodiment, the format may include one of an article, a video, and a script. The format may be selected based on a prior custom solution that was provided to the user, a success rate for the format, etc.

In one embodiment, the feedback may be requested using an out-of-band communication channel.

In one embodiment, the solution recommendation computer program may determine whether the custom solution was successful by monitoring operation of the user electronic device.

In one embodiment, in response to the custom solution being successful, the solution recommendation computer program may assign a neutral sentiment score for the custom solution.

According to another embodiment, a non-transitory computer readable storage medium, may include instructions stored thereon, which when read and executed by one or more computer processors, cause the one or more computer processors to perform steps comprising: receiving, from a user electronic device for user, a message comprising an identifier for a computer issue, an application issue, a network issue, or a remote location issue; identifying, using a trained machine learning engine, a solution category for the computer issue, wherein the trained machine learning engine is trained using historical service data and historical sentiment scores; retrieving a custom solution for the solution category from a knowledge base; determining whether the custom solution was successful; in response to the custom solution being successful, assigning a neutral sentiment score for the custom solution; in response to the custom solution being unsuccessful, requesting feedback on the custom solution from the user electronic device; receiving the feedback from the user electronic device; assigning a sentiment score to the custom solution based on the feedback, wherein the sentiment score is positive, neutral, or negative; and retraining the trained machine learning engine using the sentiment score.

In one embodiment, the non-transitory computer readable storage may also include instructions stored thereon, which when read and executed by one or more computer processors, cause the one or more computer processors to perform steps comprising: identifying a format for the custom solution, wherein the format comprises one of an article, a video, and a script; and providing the custom solution in the format.

In one embodiment, the format may be selected based on a prior custom solution that was provided to the user, a success rate for the format, etc.

In one embodiment, the non-transitory computer readable storage medium may also include instructions stored thereon, which when read and executed by one or more computer processors, cause the one or more computer processors to monitor operation of the user electronic device to determine if the custom solution was successful.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for capturing sentiments and delivering elevated proactive user experience according an embodiment;

FIGS. 2A and 2B depict a method for capturing sentiments and delivering elevated proactive user experience according an embodiment;

FIG. 3 depicts an exemplary computing system for implementing aspects of the present disclosure.

### DETAILED DESCRIPTION OF PREFERRED EMBODIMENTS

Embodiments generally relate to systems and methods for automated data quality semantic constraint identification using rich data type inferences.

Embodiments may create a “Single Pane of Glass” designed from a user-centric perspective that may remove application swivel chairing, may increase employee efficiency, and may reduce representative contact. The fit for purpose solution offers a scalable, and consistent self-help empowering user ticket solution experience.

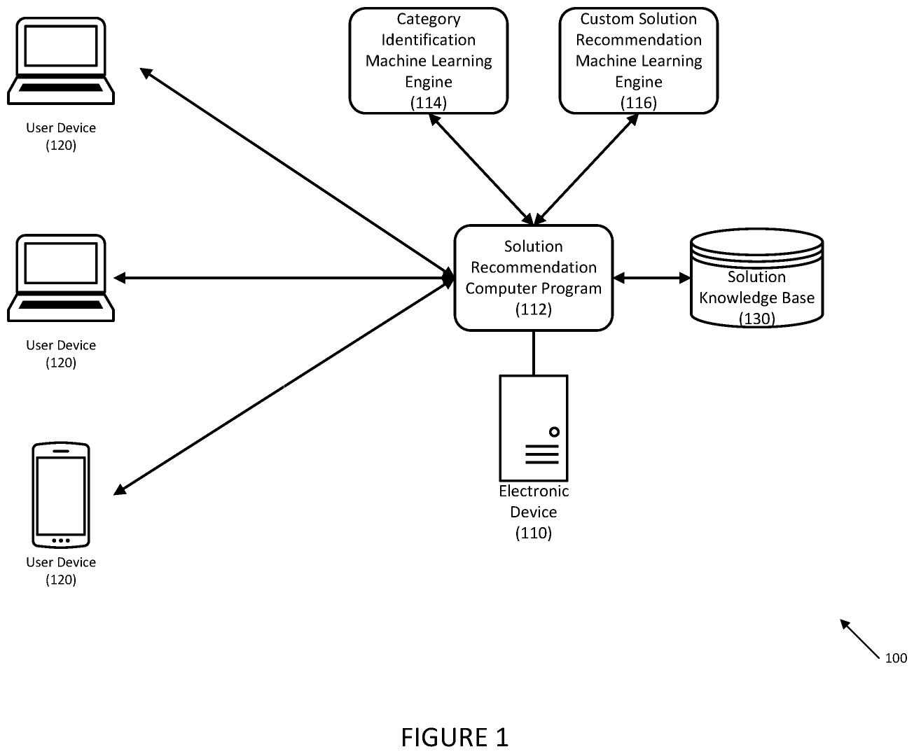

FIG. 1 depicts a system for capturing sentiments and delivering elevated proactive user experience according to an embodiment. For example, system 100 may include electronic device 110, which may be any suitable electronic device, including servers (e.g., physical and/or cloud-based), computers (e.g., workstations, desktops, notebooks, tablets, etc.), smart devices, Internet of Things (IoT) appliances, etc. Electronic device 110 may execute computer program 112, such as a solution recommendation computer program, which may interact with a plurality of user devices 120. User devices may be any suitable electronic device, including computers (e.g., workstations, desktops, notebooks, tablets, etc.), smart devices, Internet of Things (IoT) appliances, etc.

In one embodiment, user devices 120 may submit service tickets or service requests to solution recommendation computer program 112. The service tickets or service requests may include a user identification, a description of the issue, a date and time of submission, etc.

The service tickets or service requests may be received from user devices 120 via email, short messaging service (SMS) messages, via a service management program, Operating System native application, from a computer application, etc. In one embodiment, the service requests or service tickets may have a specific format, or they may be written in natural language.

Solution recommendation computer program 112 may receive the service ticket and may identify a potential solution to the problem. For example, solution recommendation computer program 112 may, if necessary, process the service ticket or service request using category identification machine learning engine 114 to identify a solution category for the issue, and may provide the solution category to solution recommendation machine learning engine 116. Category identification machine learning engine 114 may be trained to identify the solution category for the issue using, for example, natural language processing, and custom solution recommendation machine learning engine 116 may be trained to identify a solution to the service issue. For example, category identification machine learning engine 114 and custom solution recommendation machine learning engine 116 may be trained, for example, by supervised training, using, for example, historical service data, as well as historical sentiment scores.

Once the solution is identified, solution recommendation computer program 112 may retrieve information associated with the solution from solution knowledge base 130. Solution knowledge base 130 may include, for example, solution articles, crowd-source solutions, video self-help, patches, scripts, etc.

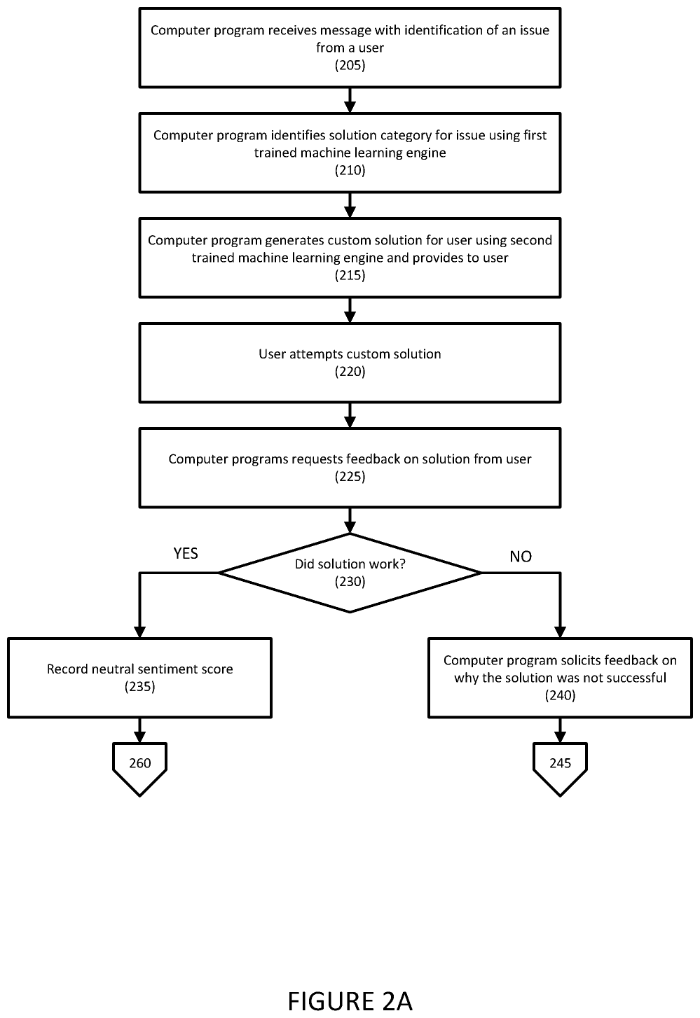

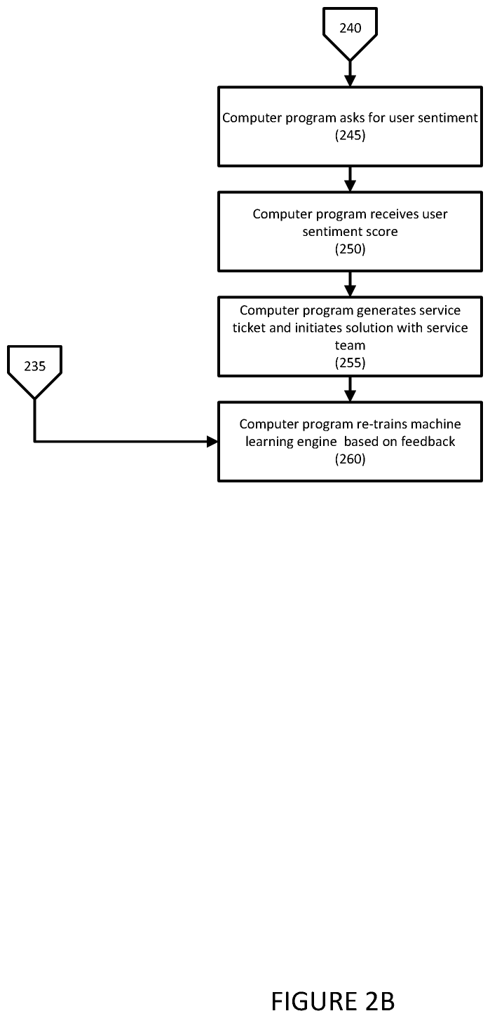

Referring to FIGS. 2A and 2B, a method for capturing sentiments and delivering elevated proactive user experience is disclosed according to an embodiment. In step 205, a computer program, such as a solution recommendation computer program, may receive a message with identification of an issue from a user. The message may be received by, for example, email, SMS message, from a service management program, from a computer application, etc. The issue may be identified using a particular format, or it may be identified using natural language.

The computer program may perform any natural language processing needed on the message to identify the issue as is necessary and/or desired.

In step 210 the computer program may identify a solution category using a first trained machine learning engine. For example, a category identification machine learning engine may be trained using historical data to identify a solution category for the issue in the message. In one embodiment, the category identification machine learning engine may use natural language processing to identify the solution category.

In step 215, the computer program may generate a custom solution for the solution category using a second trained machine learning engine, and may provide the custom solution to the user. For example, a custom solution recommendation machine learning engine may be trained to identify a custom solution for the solution category. The custom solution recommendation machine learning engine may identify a solution in a solution knowledge database, such as a solution article, crowd-source solutions, a self-help video, patches, scripts, results of an Internet search for a solution, automated batch solutions based on previous selection made by user, etc.

The solution information may be provided to the user via the communication channel on which the message was received, on a different communication channel, etc.

In one embodiment, the custom solution may be provided to the user in any suitable format (e.g., article, video, text, automated solution, etc.) based on the user's preferences, a prior selection made by the user, based on a success rate of the format of the solution, etc.

In step 220, the user may attempt to solution to the issue.

In step 225, the computer program may request feedback from the user on the effectiveness of the solution. In one embodiment, the computer program may send an email, a SMS message, an in-app message, etc. requesting information on the solution.

In one embodiment, the feedback may be requested over an out-of-band communication channel (e.g., a communication channel other than the communication channel over which the custom solution is provided).

In one embodiment, the computer program may request binary feedback from the user, such as a yes or no answer.

In another embodiment, the computer program may monitor the operation of the user's electronic device to see if the solution was effective.

In step 230, if the solution worked, in step 235, the computer program may assign a neutral sentiment score to the solution.

If the solution did not work, in step 240, the computer program may solicit feedback on why the solution was not successful. In one embodiment, the user may be given a menu of several choices, and may select one or more reasons.

In step 245, the computer program may solicit the user's sentiment regarding the solution attempt, and, in step 250, the user may provide the user's sentiment. For example, the user may select a score from 1-5, may select unhappy, neutral, happy, etc. Any suitable manner of receiving the user's sentiment may be used as is necessary and/or desired.

The computer program may use the sentiment to assign a sentiment score.

In step 255, the computer program may open a service ticket for the issue, and may forward the service ticket for resolution.

In step 260, the computer program may use the sentiment score to train the solution recommendation computer program with the effectiveness of the solution.

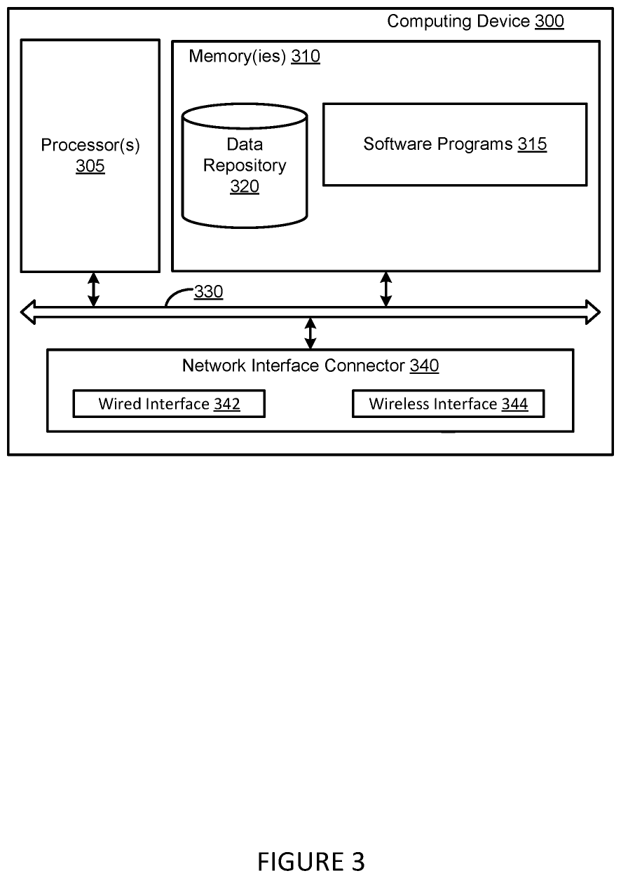

FIG. 3 depicts an exemplary computing system for implementing aspects of the present disclosure. FIG. 3 depicts exemplary computing device 300. Computing device 300 may represent the system components described herein, including, for example, backend 112. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although multiple embodiments have been disclosed, it should be recognized that these embodiments are not exclusive to each other, and features from one embodiment may be used with other embodiments.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiment's present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a solution recommendation computer program that is executed by an electronic device and from a user electronic device for user, a message comprising an identifier for a computer issue, an application issue, a network issue, or a remote location issue;
identifying, by the solution recommendation computer program and using a trained machine learning engine, a solution category for the computer issue, wherein the trained machine learning engine is trained using historical service data and historical sentiment scores;
retrieving, by the solution recommendation computer program, a custom solution for the solution category from a knowledge base;
determining, by the solution recommendation computer program, whether the custom solution was successful;
in response to the custom solution being unsuccessful, requesting, by the solution recommendation computer program, feedback on the custom solution from the user electronic device;
receiving, by the solution recommendation computer program, the feedback from the user electronic device;
assigning, by the solution recommendation computer program, a sentiment score to the custom solution based on the feedback, wherein the sentiment scores is positive, neutral, or negative; and
retraining, by the solution recommendation computer program, the trained machine learning engine using the sentiment score.

2. The method of claim 1, further comprising:
identifying, by the solution recommendation computer program, a format for the custom solution;
wherein the solution recommendation computer program provides the custom solution in the format.

3. The method of claim 2, wherein the format comprises one of an article, a video, and a script.

4. The method of claim 2, wherein the format is selected based on a prior custom solution that was provided to the user.

5. The method of claim 2, wherein the format is selected based on a success rate for the format.

6. The method of claim 1, wherein the feedback is requested using an out-of-band communication channel.

7. The method of claim 1, wherein the solution recommendation computer program determines whether the custom solution was successful by monitoring operation of the user electronic device.

8. The method of claim 1, further comprising:
in response to the custom solution being successful, assigning, by the solution recommendation computer program, a neutral sentiment score for the custom solution.

9. A system, comprising:
a user electronic device associated with a user;
an electronic device executing a solution recommendation computer program and a trained solution recommendation machine learning engine; and
a solution knowledge base comprising solution knowledge;
wherein:
the solution recommendation computer program receives a message comprising an identifier for a computer issue, an application issue, a network issue, or a remote location issue from the user electronic device;
the solution recommendation computer program identifies, using the trained solution recommendation machine learning engine, a solution category for the computer issue;
the solution recommendation computer program retrieves a custom solution for the solution category from the solution knowledge base;
the solution recommendation computer program determines whether the custom solution was successful;
in response to the custom solution being unsuccessful, the solution recommendation computer program requests feedback on the custom solution from the user electronic device;
the solution recommendation computer program receives the feedback from the user electronic device;
the solution recommendation computer program assigns a sentiment score to the custom solution based on the feedback, wherein the sentiment score is positive, neutral, or negative; and
the solution recommendation computer program retrains the trained solution recommendation machine learning engine using the sentiment score.

10. The system of claim 9, wherein the solution recommendation computer program identifies a format for the custom solution and provides the custom solution in the format.

11. The system of claim 10, wherein the format comprises one of an article, a video, and a script.

12. The system of claim 10, wherein the format is selected based on a prior custom solution that was provided to the user.

13. The system of claim 10, wherein the format is selected based on a success rate for the format.

14. The system of claim 9, wherein the feedback is requested using an out-of-band communication channel.

15. The system of claim 9, wherein the solution recommendation computer program determines whether the custom solution was successful by monitoring operation of the user electronic device.

16. The system of claim 9, wherein, in response to the custom solution being successful, the solution recommendation computer program assigns a neutral sentiment score for the custom solution.

17. A non-transitory computer readable storage medium, including instructions stored thereon, which when read and executed by one or more computer processors, cause the one or more computer processors to perform steps comprising:
receiving, from a user electronic device for user, a message comprising an identifier for a computer issue, an application issue, a network issue, or a remote location issue;
identifying, using a trained machine learning engine, a solution category for the computer issue, wherein the trained machine learning engine is trained using historical service data and historical sentiment scores;
retrieving a custom solution for the solution category from a knowledge base;
determining whether the custom solution was successful;
in response to the custom solution being successful, assigning a neutral sentiment score for the custom solution;
in response to the custom solution being unsuccessful, requesting feedback on the custom solution from the user electronic device;
receiving the feedback from the user electronic device;
assigning a sentiment score to the custom solution based on the feedback, wherein the sentiment score is positive, neutral, or negative; and
retraining the trained machine learning engine using the sentiment score.

18. The non-transitory computer readable storage medium of claim 17, further including instructions stored thereon, which when read and executed by one or more computer processors, cause the one or more computer processors to perform steps comprising:
identifying a format for the custom solution, wherein the format comprises one of an article, a video, and a script; and
providing the custom solution in the format.

19. The non-transitory computer readable storage medium of claim 18, wherein the format is selected based on a prior custom solution that was provided to the user or based on a success rate for the format.

20. The non-transitory computer readable storage medium of claim 17, further including instructions stored thereon, which when read and executed by one or more computer processors, cause the one or more computer processors to monitor operation of the user electronic device to determine if the custom solution was successful.
